(19) United States
(12) Patent Application Publication
(10) Pub. No.: US 2014/0358343 A1
(43) Pub. Date: Dec. 4, 2014

(54) VEHICLE TIRE FRICTIONAL DRIVE ROTATIONAL POWER AND ENERGY SOURCE

(71) Applicant: Raymond Louis Chastang, JR., Inkster, MI (US)

(72) Inventor: Raymond Louis Chastang, JR., Inkster, MI (US)

(21) Appl. No.: 14/288,723

(22) Filed: May 28, 2014

Related U.S. Application Data
(60) Provisional application No. 61/827,812, filed on May 28, 2013.

(51) Int. Cl. B60L 11/00

(52) U.S. Cl. CPC B60L 11/002
USPC 701/22

(57) ABSTRACT

The tire friction drive rotational power and energy source provides a means of harvesting energy from a rotating tire of a vehicle in motion with minimal energy impact on vehicle power source. Rotational inertia or energy is transferred from one or more tires through friction to turn an energy producing device, such as an alternator. The alternator tire (cylindrical roller) makes contact with one or more vehicle tires for energy transfer, rotating via a shaft equipped with roller bearings with the shaft connected to the alternator pulley, thereby harvesting energy while the vehicle is in motion. In the primary embodiment, the harvested energy is used to power an accessory in any powered vehicle regardless of the energy source. An alternative embodiment deploys the harvested energy to potentially extend the range of an electric vehicle.

This application is related to and claims priority to U.S. Provisional Application No. 61/827812, entitled “Electric Vehicle Battery Charging Tire Frictional Drive Rotational Power and Energy Source”, by Raymond Louis Chastang, Jr., filed on May 28, 2013.

### FIELD OF USE

The present invention relates to harvesting energy from a rotating tire of a vehicle in motion which can have minimal energy impact on vehicle power source, and more particularly, transferring rotational energy from one or more tires through friction to turn an energy producing device, such as an alternator.

### BACKGROUND OF THE INVENTION

A number of methods are being developed to increase the range of electric vehicles.

U.S. Patent Document No. 20130073128 (Timmons et al.) discloses an electric vehicle includes a transmission, motor, rechargeable energy storage system, auxiliary power unit, and a controller. The APU has a pair of rings, at least one of which rotates with respect to the other. One ring is coaxial with and radially within the other. Ring rotation generates current in windings. A gear element is in driving connection with the rotatable ring. The auxiliary power unit includes an engine disposed radially within the inner ring, and a power takeoff mechanism coupled to the gear element. The controller energizes the auxiliary power unit to rotate a ring. A method includes positioning the auxiliary power unit in a vehicle body compartment, affixing an outer ring of windings to a compartment wall, and positioning a rotatable inner ring having permanent magnets radially within and coaxial with the outer ring.

U.S. Patent Document No. 20120041625 (Kelty et al.) depicts a method for the efficient dual source battery pack system for an electric vehicle, where the power source is comprised of a first battery pack (e.g., a non-metal-air battery pack) and a second battery pack (e.g., a metal-air battery pack). The power source is optimized to minimize use of the least efficient battery pack (e.g., the second battery pack) while ensuring that the electric vehicle has sufficient power to traverse the expected travel distance before the next battery charging cycle.

U.S. Patent Document No. 20120041624 (Stewart et al.) discloses a power source comprised of a first battery pack (e.g., a non-metal-air battery pack) and a second battery pack (e.g., a metal-air battery pack) is provided, wherein the second battery pack is only used as required by the state-of-charge of the first battery pack or as a result of the user selecting an extended range mode of operation. Minimizing use of the second battery pack prevents it from undergoing unnecessary, and potentially lifetime limiting, charge cycles. The second battery pack may be used to charge the first battery pack or used in combination with the first battery pack to supply operational power to the electric vehicle.

EU Publication No. EP2563634 (Friadl) discloses a method for operating an electric vehicle having at least one electric drive machine, at least one electric energy store and at least one current-generating device which is formed, in particular, by a range extender, said current-generating device being activated in accordance with state of charge of the electric energy store and of the route. All possible routes are simulated, starting from a reference point which preferably corresponds to the starting point of the route, within a defined area of travel, and a prospective activation time of the current-generating device is determined for each of the simulated routes, in order to maintain a defined state of charge of the energy store once the area of travel has been reached. It is therefore possible to extend the range of electric vehicles using current-generating devices with smallest possible dimensions even if the destination is not defined.

U.S. Patent Document No. 20110313652 (Hancock) discloses a system for managing energy capacity in an electric vehicle based on a driver profile. This is achieved by various means, including interactively determining a travel plan with a user, calculating a total travel distance for the travel plan, determining how far the electric vehicle can travel based on its current energy level, and creating an energy replenishment plan based on the travel plan, the total travel distance, how far the vehicle can currently travel, and the driver profile.

What is needed is a system and method which will extend the range of these electric vehicles to more closely match or surpass the ranges of current typical internal combustion engine vehicles to minimize the need for a driver to stop and recharge. What is needed is a system where charging occurs overnight while the vehicle is not being used, the vehicle being plugged into a wall outlet while the driver is sleeping. What is needed is a system and method that if the driver forgets to charge or cannot charge the vehicle for some other reason, the vehicle still has enough range so the driver need not worry about being able to complete a regular commute the next day.

### SUMMARY OF THE INVENTION

The energy harvesting tire friction drive rotational power and energy source system and method of the present invention addresses these needs and can play an important part in addressing range extension needs for electric vehicles.

The present invention relates generally to the field of batteries and battery systems. More specifically, the present application relates to batteries and battery systems that may be used in vehicle applications to provide at least a portion of the motive power for the vehicle.

A primary purpose of the tire friction drive rotational power and energy source system and method of the present invention is to use the rotational energy created by one or more wheels of a moving vehicle to aid in supplying auxiliary power to a device or to a system with various power requirements. The system provides a means of harvesting energy from a rotating tire of a vehicle in motion. Rotational inertia and energy is transferred from one or more tires through friction, which can then be used to turn power-driven vehicle accessories and devices, such as alternators, water pumps, hydraulic pumps, generators, and the like. These accessories can be on conventional gasoline powered vehicles, and a whole array of vehicles using other power sources, such as by way of non-limiting example, as vehicles that are powered by hydrogen, compressed natural gas, diesel, hybrid, solar, compressed air, battery-electric, dimethyl ether (dme), ammonia, biofuels, bioalcohol and ethanol, biodiesel, biogas, charcoal, compressed natural gas (cng), liquid nitrogen, flexible fuel, autogas, or steam.

A primary purpose of the battery charging tire friction drive rotational power and energy source system and method is to use the rotational energy created by a wheel of an electric vehicle while being driven to recharge the battery of said electric vehicle, reducing, or potentially eliminating the need to stop and recharge the vehicle batteries. The system provides a means of harvesting energy from a rotating tire of a vehicle in motion which can have minimal energy impact on vehicle power source depending on the system application and configuration of the system components. Rotational inertia and energy is transferred from one or more tires through friction to turn energy producing devices, such as an alternator.

In an electric vehicle with two battery banks, the output power of the alternator can be used to re-charge the first battery while the second battery is discharging. When necessary, automatically, the alternator can be set to charge the depleted second battery while the vehicle utilizes new energy from first battery, all while the electric vehicle is in motion. The alternator could also be used to provide electrical energy to power many types of on-board mobile equipment such as refrigeration units or entertainment devices.

The system has the ability to emulate the driving range of a larger battery, which reduces the need for a large battery. A smaller battery will also aid in extending the driving range further due to the reduced weight of the vehicle. The system has numerous applications in the commercial logistics industry that involve operating equipment while a vehicle is in motion over long distances. Other devices that can be powered using this application are: generators, dynamos, compressors, hydraulic pumps, water pumps, or gear pumps.

As the battery charging the tire friction drive rotational power and energy source system and method of the present invention may be embodied in many forms without departing from the spirit of essential characteristics thereof, it is expressly understood that the drawings are for purposes of illustration and description only, and are not intended as a definition of the limits of the invention.

### BRIEF DESCRIPTION OF THE DRAWINGS

All drawings illustrate the device transferring rotational energy to an alternator device, but as mentioned, many types of devices could be used in its place.

FIG. 1 depicts a general schematic of a first preferred embodiment of the battery charging the tire friction drive rotational power and energy source system of the present invention.

FIG. 2A depicts a simplified rear view of the preferred embodiment of a first rotational energy capture system for the vehicle tire friction drive rotational power and energy source system of the present invention.

FIG. 2B depicts a simplified front view of the preferred embodiment of the first rotational energy capture system for the vehicle tire friction drive rotational power and energy source system of FIG. 2A.

FIG. 2C depicts a simplified top isometric view of the preferred embodiment of the first rotational energy capture system for the vehicle tire friction drive rotational power and energy source system of FIG. 2A.

FIG. 2D depicts a simplified top isometric view of the preferred embodiment of the first rotational energy capture system for the vehicle tire friction drive rotational power and energy source system of FIG. 2A.

FIG. 2E depicts a simplified offset isometric view of the preferred embodiment of the first rotational energy capture system for the vehicle tire friction drive rotational power and energy source system of FIG. 2A, with DETAIL “A” showing a view of the alternator pulley, the drive belt, and the tensioner, DETAIL “B” showing a view of the screw motor sitting atop the spring and damper assembly, and DETAIL “C” showing a view of the support bracket.

FIG. 2F depicts a simplified end view of the preferred embodiment of the first rotational energy capture system for the vehicle tire friction drive rotational power and energy source system of FIG. 2A.

FIG. 2G depicts another simplified end view of the preferred embodiment of the first rotational energy capture system for the vehicle tire friction drive rotational power and energy source system of FIG. 2A.

FIG. 2H depicts a simplified top view of the preferred embodiment of the first rotational energy capture system for the vehicle tire friction drive rotational power and energy source system of FIG. 2A.

FIG. 3 depicts a chart containing sample calculations showing an example of a configuration scenario for the tire friction drive rotational power and energy source system of the present invention.

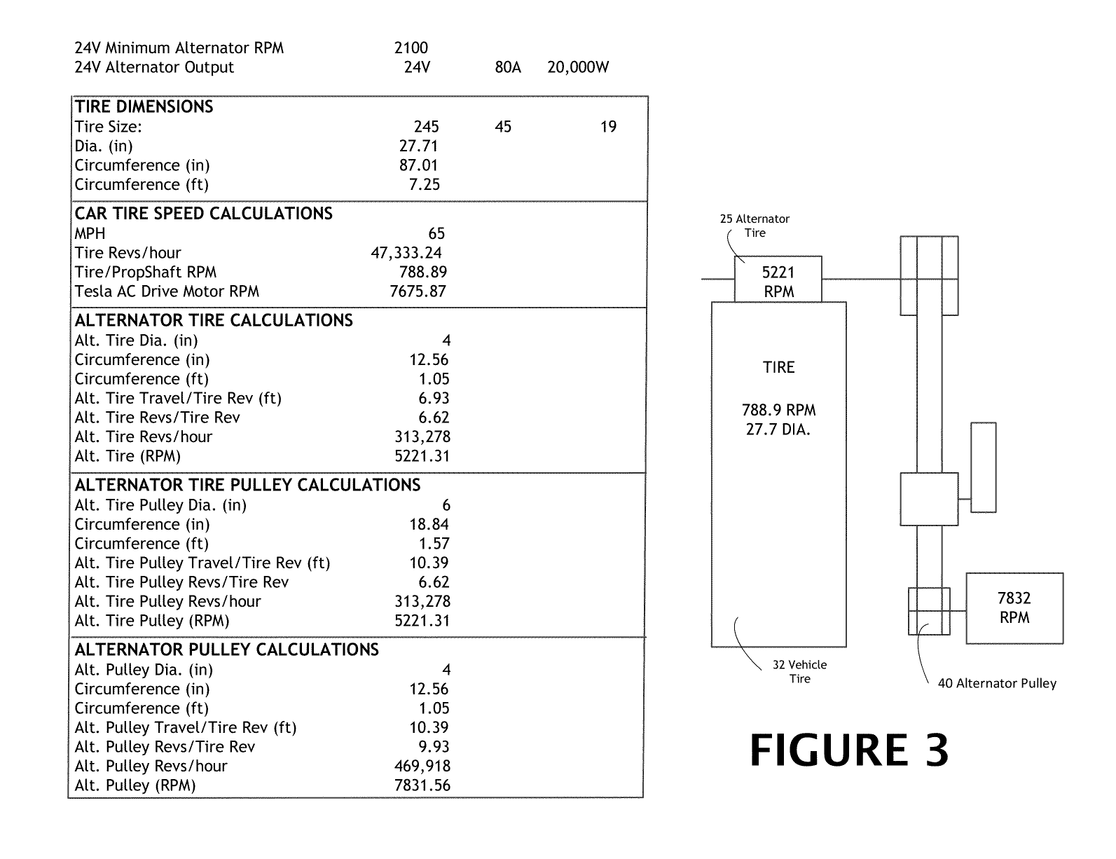

FIG. 4 depicts a simplified top view of the preferred embodiment of the tire friction drive rotational power and energy source system of the present invention as it would appear from the top of FIG. 2A, with “DETAIL A” of the shaft and roller bearings for the alternator tire.

FIG. 5A depicts a general schematic of a second preferred embodiment of the battery charging the tire friction drive rotational power and energy source system of the present invention, the system layout deploying the energy capture embodiment of the battery charging tire friction drive rotational power and energy source system of the present invention.

FIG. 5B depicts a general schematic of a third preferred embodiment of the battery charging the tire friction drive rotational power and energy source system of the present invention, the system layout being of an electric vehicle with two batteries of the same or similar capacity that deploys the energy capture embodiment of the battery charging tire friction drive rotational power and energy source system of the present invention.

### DETAILED DESCRIPTION OF THE PREFERRED EMBODIMENT

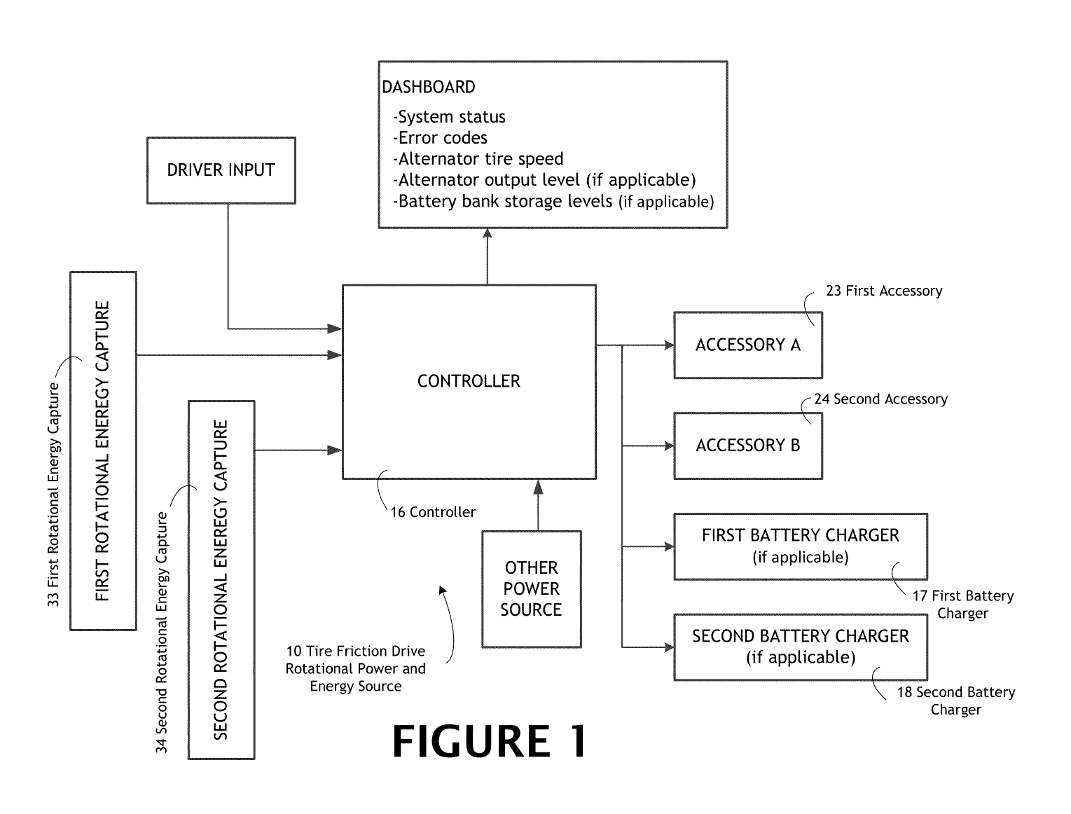

Referring now to the drawings, FIG. 1 depicts the tire friction drive rotational power and energy source system of the present invention. The system [10] of the present invention for harvesting energy from a first wheel of a moving vehicle, comprises a mechanism for capturing rotational energy of the first wheel of a moving vehicle [33], and a device [16] for providing and controlling power to a vehicle accessory, the power using the captured rotational energy. The controller [16] receives power from multiple power sources and transmits the energy to one or more accessories directly as said energy is needed and as the energy becomes available. If the vehicle has a battery, the harvested energy can be stored in the battery and used as needed.

The versatility of the design can be used in many different configurations to suit several applications on a wide range of vehicles. Passenger cars, trucks, buses, and semi-trailer trucks (18 wheelers) can use this device to power or store energy for multiple types of on-board equipment such as refrigeration units, battery banks, or the like. For the trailers of long-range commercial vehicles with multiple sets of wheels, several instances of the device are installed and used to harvest rotational power from many of the wheels to constantly power on-board equipment.

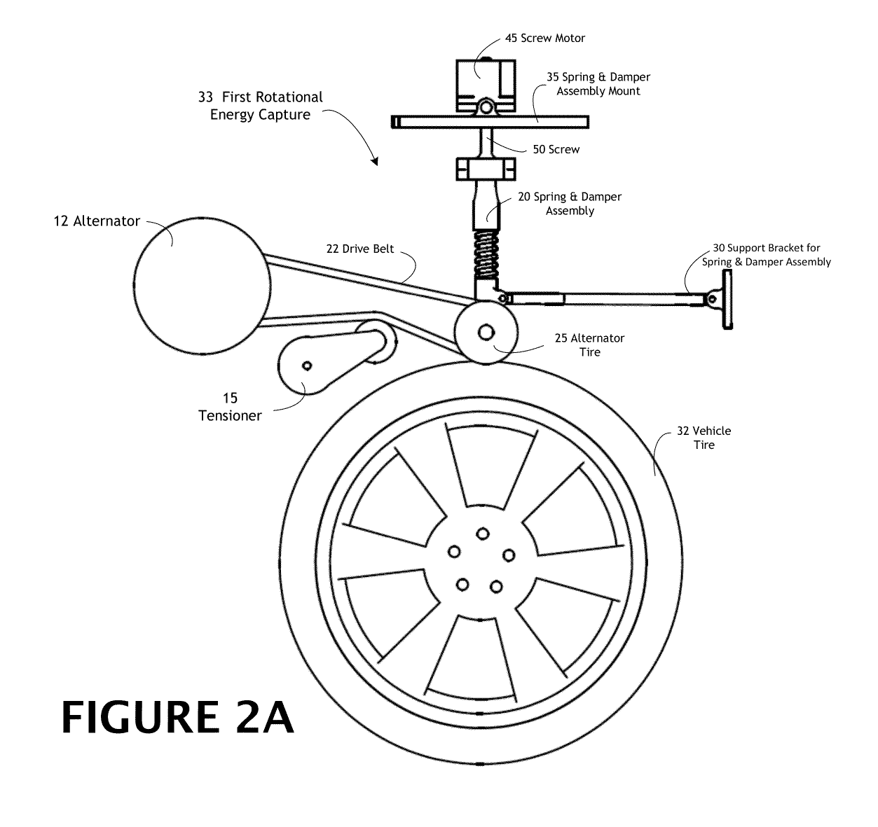

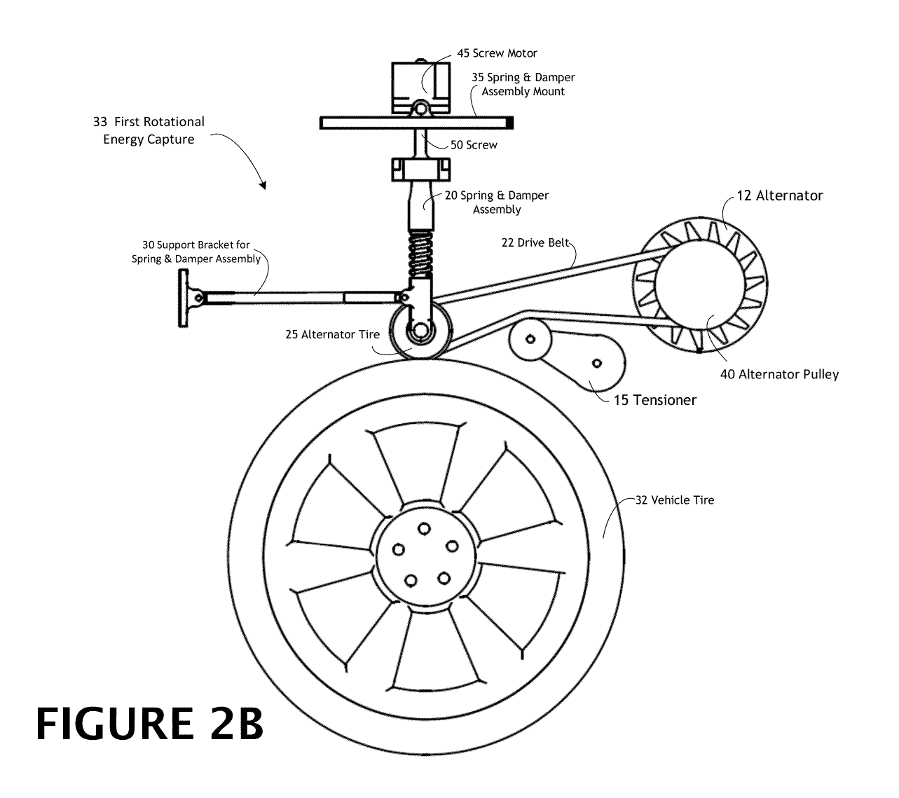

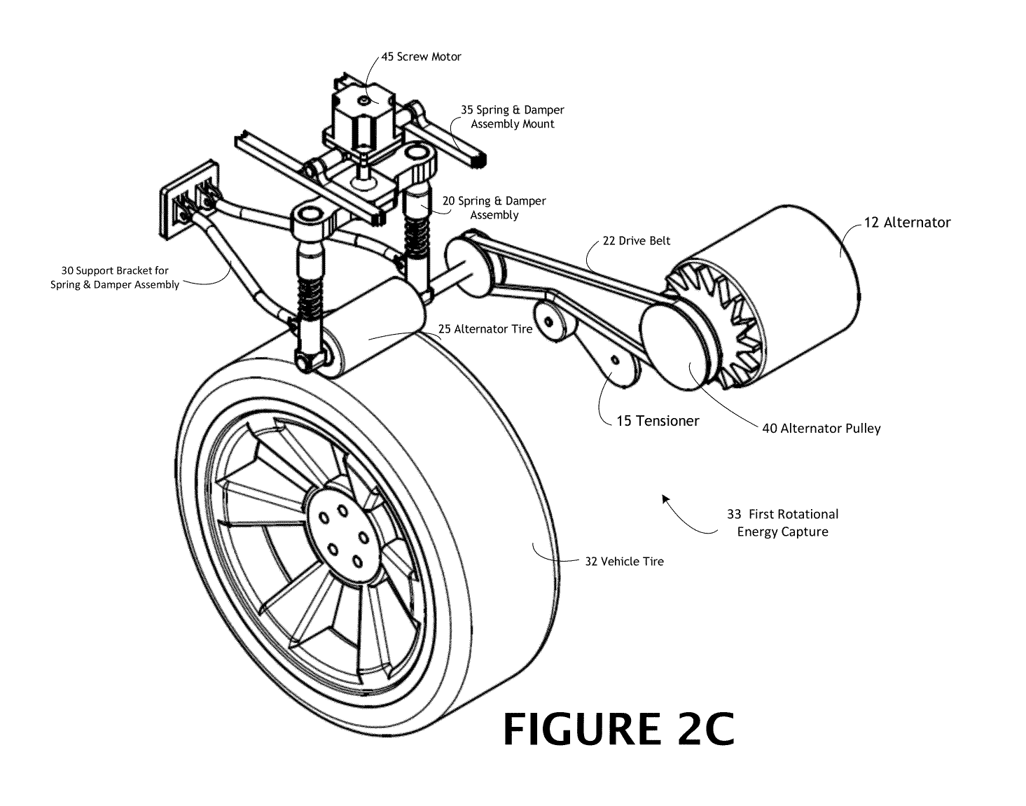

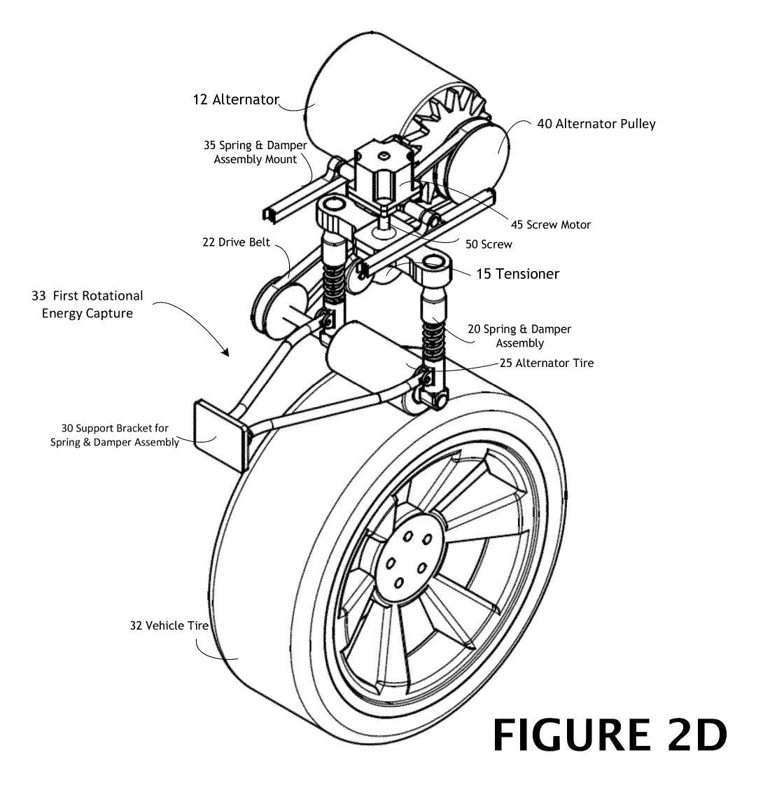

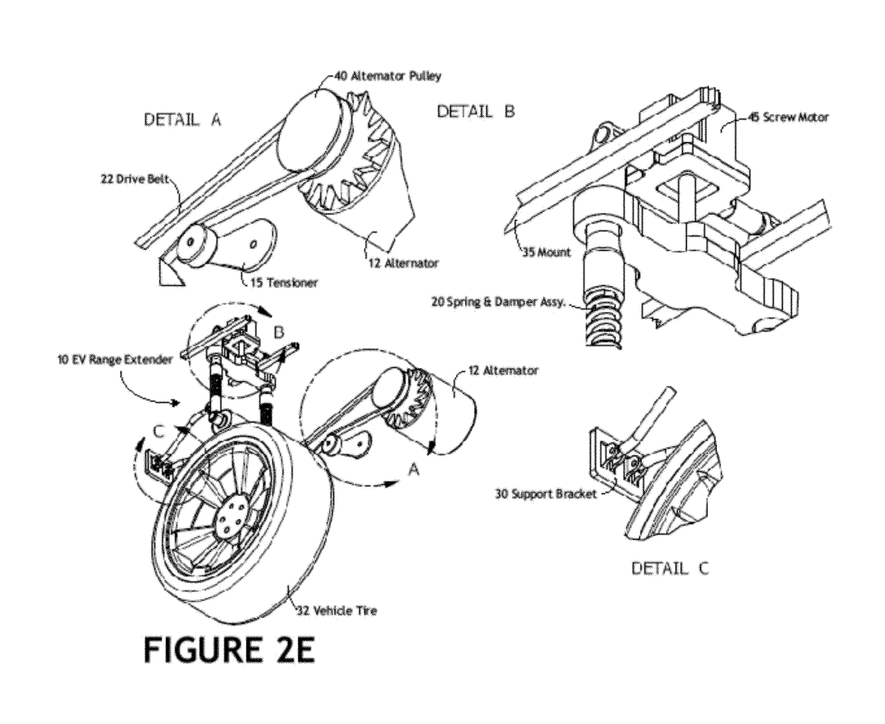

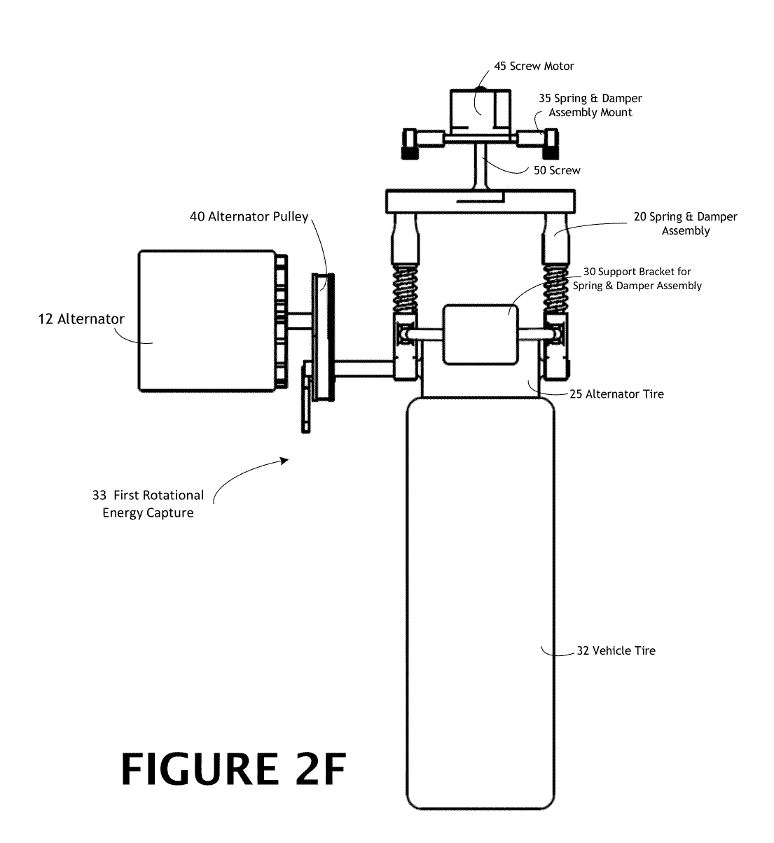

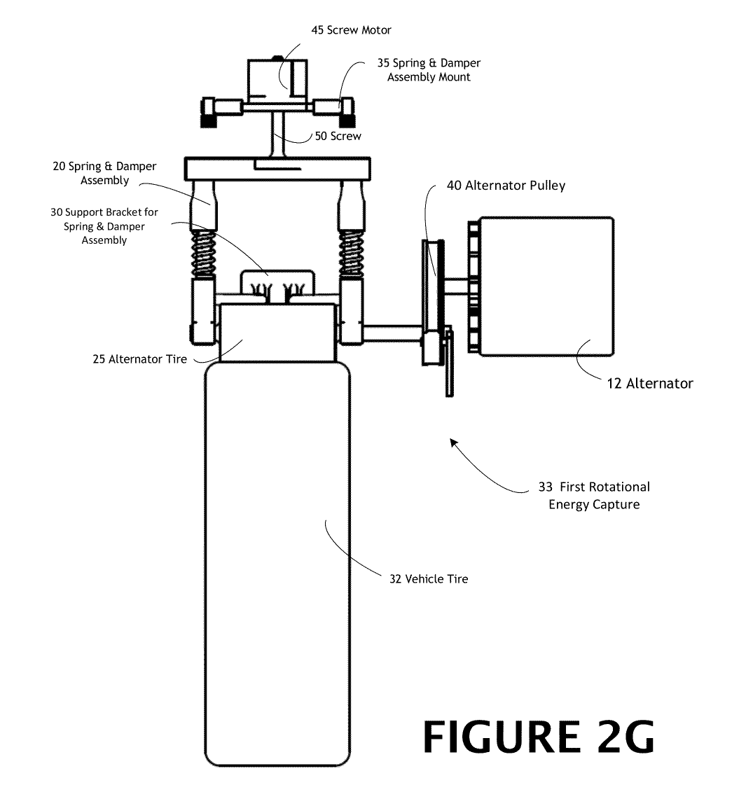

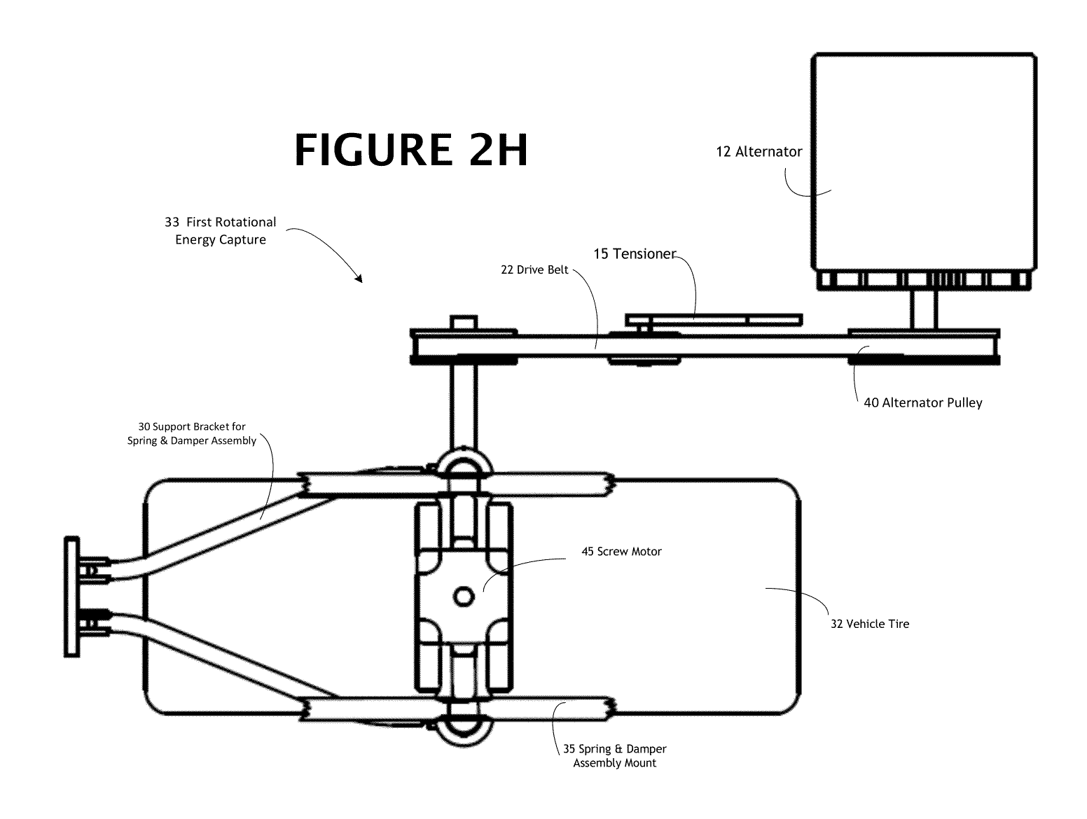

FIGS. 2A through 2H depict the preferred embodiment of a first wheel of a moving vehicle [33] from various perspectives: rear, front, top, and offset profiles in which the rotational energy of the vehicle tire [32] drives the alternator tire [25], which in turn drives the alternator [12] via drive belt [22], engaged against the alternator [12] via alternator pulley [40] with a belt tensioner [15] maintaining belt tension. The alternator tire [25] is mechanically connected to a spring and damper assembly [20] which is connected to the vehicle via spring and damper assembly mount [35] located at the top of the spring and damper assembly [20]. On top of the spring and damper assembly mount [35] is a stepper motor powered linear actuating screw [45] which operates a screw [50] retracting the spring and damper assembly [20] when the system is not in use, or when maintenance must be performed on the vehicle requiring the removal of the wheel.

Screw stepper motors used as a linear actuator have a static loading capacity, meaning that when the motor stops the actuator essentially locks in place and can support a load that is either pulling or pushing on the actuator. This static load capacity of the screw drive enables the device's spring and damper system to absorb and handle nearly 100% of the shock loading introduced to the device created from the cracks, holes, and other uneven conditions of the road being driven on. In addition, screw drives have the ability to apply a range of different degrees of force in the forward and reverse directions with minimal power needed by the motor. This feature gives the device the ability to make automatic adjustments on the fly to keep constant non-slip contact with the wheel. Lateral stability is provided by the spring and damper assembly stabilizer bracket [30] preventing the spring and damper assembly [20] and alternator tire [25] from moving laterally while the vehicle is in motion. The spring and damper assembly [20] ensures the alternator tire [25] maintains contact with the vehicle tire [32] during all driving conditions as well as following the vehicle suspension movement when driving over irregular surfaces. The spring and damper assembly stabilizer bracket [30] prevents the lateral movement of the system, which would, not only increase wear and tear on the vehicle tire [32] but would also translate to wasted energy as the lateral motion would waste potential energy which could be used to drive the alternator [12]. The belt-tensioner tensioner [15], by maintaining belt tension, prevents belt slippage, which will also make the system less efficient by reducing the rotational energy which can be imparted on the alternator. Slippage would also increase wear and tear on the system as it would require more energy to drive the system of the present invention, draining the vehicle power source more quickly, while also wearing the components of the system of the present invention more quickly. The screw motor [45] has a pivot point located at its base enabling the base and the remaining assembly below said screw motor to have freedom of rotational movement as the vehicle is in motion and when the system engages/disengages. All of the pivot points are designed to prevent binding or twisting while the system is in use and under load.

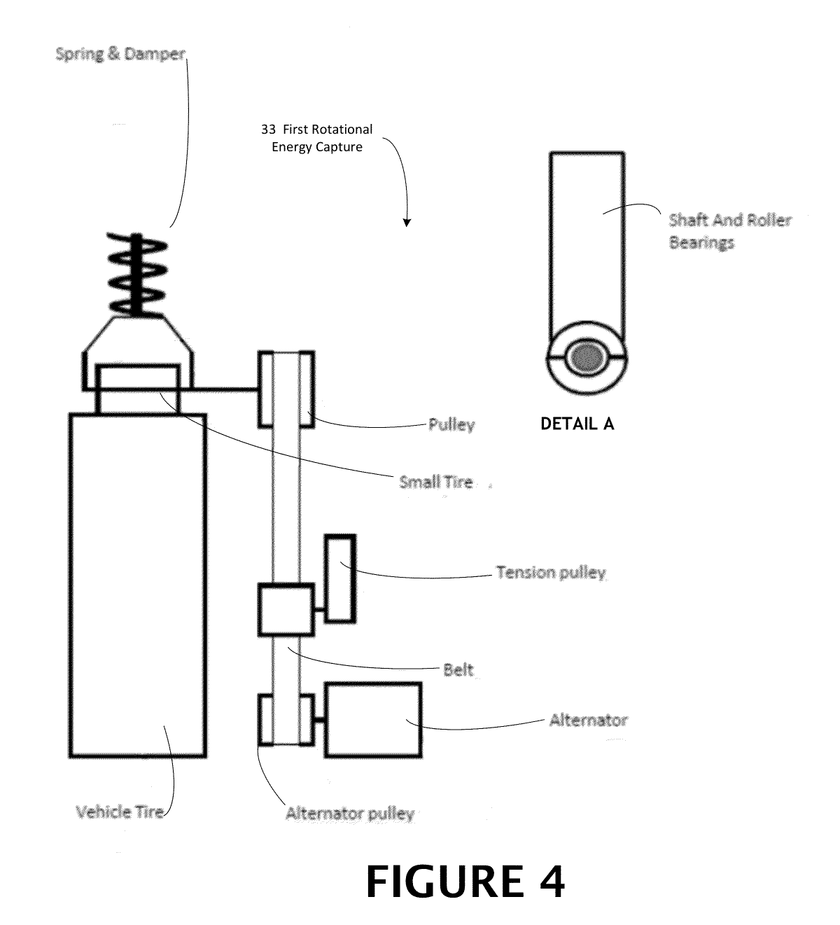

FIG. 4 is a diagram of the tire friction drive rotational power and energy source as described in FIG. 1 with the shaft and roller bearings [42] for the alternator tire [25] visible.

Vehicle powered accessories have been integrated into automobiles, cars, SUV's, vans, and light trucks. Such accessories, to name just a few, include everything from deluxe security systems, entertainment units and centers, keyless entry, remote starters, global positioning and other navigational systems, mirrors, sunroofs, moon-roofs, convertible tops, internal lighting systems, custom consoles and dashes, trim packages, body side moldings, body trim, trim accessories, kit packages, air bags, heated seats, refrigeration units, braking systems, performance suspension systems and engine modifications, such as turbo-superchargers which greatly increase engine power output.

The following are two modes of examples of the features that the “controller” can possess given the use of the tire friction system for charging an auxiliary battery bank via alternator. Depending upon the type of rotary powered device is in use (alternator, pump, hydraulic, or whatever) and what type of vehicle the tire friction drive rotational power and energy source system of the present invention is installed on, such features can be adapted to give the driver of the vehicle the most beneficial experience and to encourage the longevity of all the components used in the overall system.

The automatic mode is designed to preserve the overall life of battery bank, alternator, and other friction drive components. In one preferred embodiment the system activates once the vehicle reaches a speed of 60 MPH for a duration of five minutes. The system deactivates once the vehicle is moving at a speed of less than 60 MPH for a duration of one minute. The system deactivates after vehicle experiences 10 seconds of rough terrain. The system deactivates after experiencing excessive slippage between alternator tire and vehicle tire or pulley and belt components.

The manual mode is aimed to give driver activation control during highway driving and still provide some protections for the lifetime preservation of battery bank and friction drive components. In one preferred embodiment the system can be activated at any time. The system deactivates every time the vehicle stops. The driver will need to manually re-activate the system to resume system functions. The system deactivates after vehicle experiences 10 seconds of rough terrain. The system deactivates after experiencing excessive slippage between alternator tire and vehicle tire or pulley and belt components.

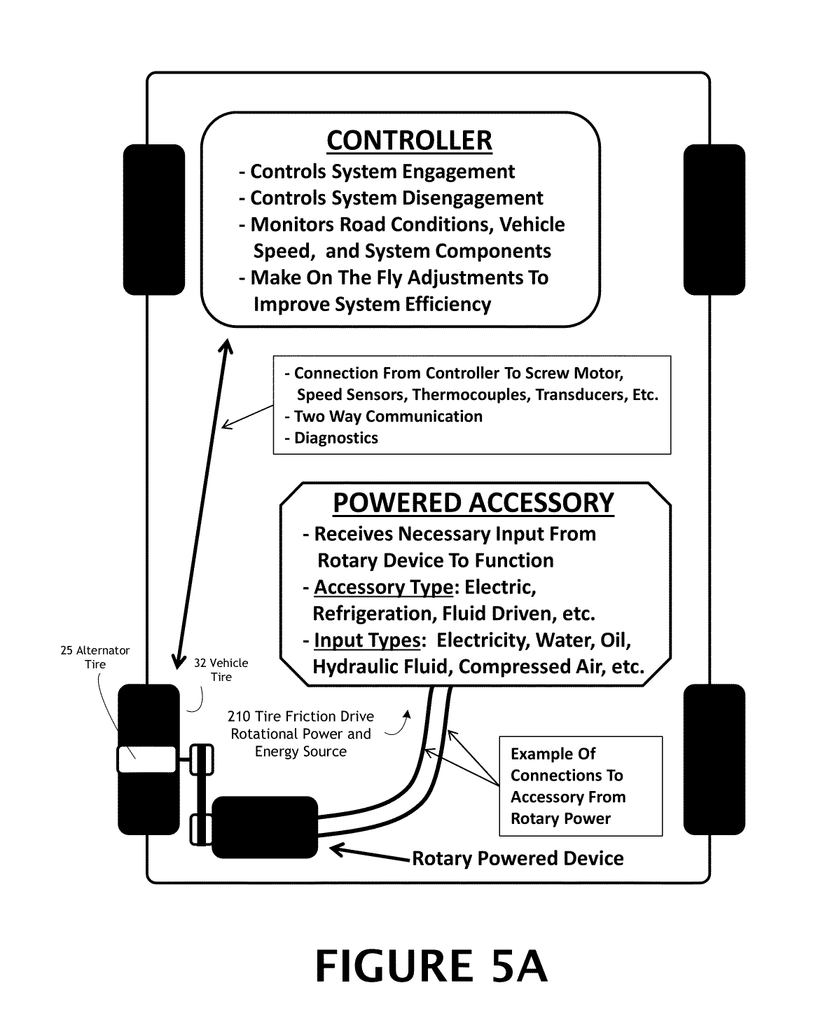

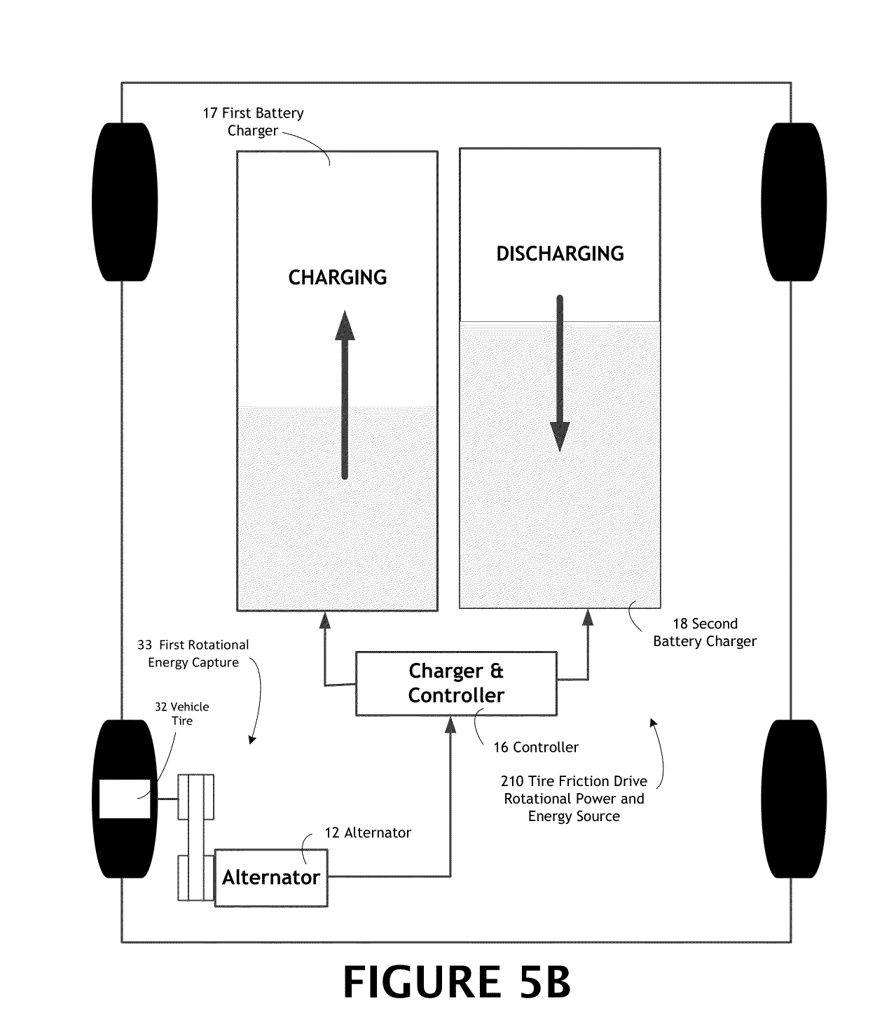

FIG. 5A depicts a general schematic of a second preferred embodiment of the battery charging the tire friction drive rotational power and energy source system [110] of the present invention. The system layout deploys the energy capture embodiment [33] of the battery charging tire friction drive rotational power and energy source system of the present invention. The versatility of the design enables the system to be used in many different configurations to suit a wide variety of applications on any vehicle. Passenger cars/trucks, buses, and semi-trailer trucks (18 wheelers) can utilize this device to power or store energy for multiple types of on-board equipment such as refrigeration units, battery banks, etc. For the trailers of long range commercial vehicles with multiple sets of wheels, several instances of the device could be installed and utilized to harvest rotational power from many of those wheels to constantly power on-board equipment.

FIG. 5B depicts a third preferred embodiment of the tire friction drive rotational power and energy source of the present invention [210]. One skilled in the art will readily see that the principles of the present invention can potentially be applied to extend the range of an electric vehicle. In this scenario, said vehicle needs to maintain a constant supply of power in a set of auxiliary battery banks. The illustrated vehicle includes a battery charging apparatus coupled with a controller for managing the friction drive system. The output power of the alternator [12] is used to re-charge the first battery [17] while the second battery [18] is discharging (powering auxiliary electrical devices). When necessary, automatically, the alternator [12] can be set to charge the depleted second battery [18] while the electrical device utilizes new energy from the first battery [17], all while the electric vehicle is moving. With the tire friction drive rotational power and energy source of the present invention [110], there is no need to carry extra battery packs to keep auxiliary electrical devices powered or to stop anywhere along the driving route to swap battery banks. The system has the ability to emulate larger battery banks, reducing the need for a bank of batteries resulting in significant weight reduction.

Instead of merely propelling or carrying (i.e. trailer tires) the vehicle, the wheels of the vehicle in motion are used for more purposes. This notion is more apparent when witnessing a large industrial heavy haul trucks pulling trailers that have several more sets of tires than an average semi-trailer truck. The wheels of roadworthy vehicles rotate rapidly and are driven by powerful engines. Given the large diameter and quick rotation, with a given drive/prop shaft RPM, the travel distance of the tires outer diameter surface is always much greater. Some of the energy being transmitted through the tire can be harvested by using friction, in which the travel speed and power of this outer diameter can be physically applied to an additional free rolling type element; wherein this free rolling element can be part of a device that funnels harvested energy towards many different applications. The tire material is generally comprised of rubber that increases in temperature when in motion. These properties make a friction drive type energy harvesting system quite feasible in regards to inhibiting slippage and maintaining a secure connection.

In regards to passenger vehicles, this device is more beneficial to use on types without an internal combustion engine or transmission such as electric vehicles. In combustion engine driven vehicles, energy is normally harvested from the engine crankshaft to power auxiliary devices, upstream of the transmission. In this type of vehicle, the wheels get their power from the transmission which is attached to the engine, which also controls the speed of the wheels through setting the appropriate gear configuration. The transmission is full of multiple sets of heavy duty gears and numerous components that turn against each other to drive the wheels. The transmission uses a large portion of the power of the engine to operate and regulate speed. Electric vehicles do not require a transmission to operate because the motor of the electric vehicle is connected to the wheel directly via a single gearing configuration. Without a transmission, the power produced by the electric vehicles motor travels directly to the wheels and is barely reduced by intermediary components.

This invention can be used as a key component in the development of a feasible range extending device for electric vehicles. With electric vehicles becoming more popular, and in some countries, and states, with California mandating 4% of the cars sold be zero emissions vehicles, i.e. electric vehicle, in the United States, range and charging has become an issue for existing and potential owners. While there are rapid charging stations, which will charge an electric vehicle in as little as a few hours, the number of these stations is currently sparse. It is still an inconvenience even while using a rapid charging station, to have to wait for the vehicle to be charged in addition to waiting in a line of other charging vehicles. With most electric vehicles having limited driving ranges:

The Ford Focus BEV has a range of 76 miles

The Nissan Leaf has a range of 73 miles

The Tesla Model S has a range of 230-300 miles

The ranges of these vehicles need to be extended considerably to make them more viable.

These ranges are in ideal conditions, with the addition of comfort options, such as air conditioning, or heat, plus usage of the radio, and other telematics, in combination with the outside ambient temperature will adversely affect the range of an electric vehicle. This is especially true in places where the temperatures are either sweltering or frigid. Either extreme will reduce the power capacity of a battery significantly, reducing the driving range in some cases by as much as 50%.

By using the tire friction drive rotational power and energy source system of the present invention to provide energy to heat and cool the passenger cabin of the vehicle during extreme temperature conditions, the ranges of these electric vehicles can potentially be extended. Also, if the vehicle is transporting materials that need to be refrigerated, the energy generated from the tire friction drive rotational power and energy source system of the present invention is routed and applied directly to these materials, also potentially extending the range of the electric vehicle. In both of these examples, this energy complements the energy supplied by the battery so that the temperatures do not fluctuate during stop-and-go driving.

For purposes of simplicity, only one wheel assembly [33] of the tire friction drive rotational power and energy source system is being illustrated. However, one of ordinary skill in the art will readily appreciate that the system can be readily expanded to multiple wheel assemblies.

Throughout this specification, various patent applications are referenced by application number and inventor. The disclosures of these patent applications are hereby incorporated by reference in their entireties into this specification in order to more fully describe the state-of-the-art.

It is evident that many alternatives, modifications, and variations of the vehicle tire friction drive rotational power and energy source system and method will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

10. Tire Friction Drive Rotational Power and Energy Source—First Embodiment

12. Alternator

14. Controller

15. Belt Tensioner

16. Controller

17. First Battery Charger

18. Second Battery Charger

20. Spring and Damper Assembly

22. Drive Belt

23. First Accessory

24. Second Accessory

25. Alternator Tire

30. Support Bracket

32. Tire

33. First Rotational Energy Capture

34. Second Rotational Energy Capture

35. Mount

40. Alternator Pulley

42. Shaft and Roller Bearings

45. Screw Motor

50. Screw

110. Tire Friction Drive Rotational Power and Energy Source—Second Embodiment

210. Tire Friction Drive Rotational Power and Energy Source—Third Embodiment

I claim:

1. A method of harvesting energy from a wheel of a moving vehicle, said method comprising:
a. capturing rotational energy of said wheel of a moving vehicle; and
b. providing and controlling power to a vehicle accessory, said power using said captured rotational energy.

2. The method of claim 1, further comprising using said captured power to extend driving range of said moving vehicle, said moving vehicle being an electric vehicle.

3. The method of claim 1, wherein said moving vehicle may be an electric vehicle, a hybrid, a gasoline powered vehicle, or an alternative energy powered vehicle.

4. A system for harvesting energy from a first wheel of a moving vehicle, said system comprising:
a. a mechanism for capturing rotational energy of said first wheel of a moving vehicle; and
b. a device for providing and controlling power to a vehicle accessory, said power using said captured rotational energy.

5. The system of claim 4, wherein said device for providing and controlling power is adaptable to extend driving range of said moving vehicle, said moving vehicle being an electric vehicle.

6. The system of claim 4, wherein said moving vehicle may be an electric vehicle, a hybrid, a gasoline powered vehicle, or an alternative energy powered vehicle.

7. The system of claim 4, wherein said rotational energy of said first wheel of said moving vehicle drives an alternator tire, said alternator tire in turn driving an alternator.

8. The system of claim 4, further comprising a mechanism for capturing rotational energy of a second wheel of said moving vehicle, and said device for providing and controlling power to said vehicle accessory, said power using said captured rotational energy.

9. The system of claim 4, wherein energy produced is used to power vehicle telematics with no parasitic loss on said vehicle engine, thereby increasing fuel economy.

10. The system of claim 4, wherein energy produced is used to power electric power steering, brakes and other components normally powered via a crankshaft of an engine.

11. A method of harvesting energy from a wheel of a moving vehicle, said method comprising:
a. capturing rotational energy of said wheel of a moving vehicle; and
b. using said captured power to extend driving range of said moving vehicle, said moving vehicle being an electric vehicle.

12. The method of claim 11, further comprising using said captured power to charge a first battery unit while said vehicle is being powered by a second battery unit.
